(19) United States
(12) Patent Application Publication
(10) Pub. No.: US 2010/0230559 A1
(43) Pub. Date: Sep. 16, 2010

(54) GANTRY DEVICE FOR USE IN THE ASSEMBLY OR MAINTENANCE OF HEAVY PARTS OF A TRAVELLING DEVICE

(75) Inventors: Christoph Eder, Wien (AT); Hubert Hölzl, Reisenberg (AT); Roland Kubik, Steinbrunn (AT); Thomas Illedits, Neufeld (AT); Wolfgang Neszmerak, Wien (AT)

Correspondence Address: LADAS & PARRY LLP, 26 WEST 61ST STREET, NEW YORK, NY, 10023, US

(73) Assignee: Inventio AG

(21) Appl. No.: 12/741,287

(22) PCT Filed: Nov. 10, 2008
(86) PCT No.: PCT/EP08/65218

§ 371 Date: May 4, 2010

(51) Int. Cl. F16M 11/24

(52) U.S. Cl. 248/157

(57) ABSTRACT

The invention relates to a gantry device (10) for use in the assembly or maintenance of heavy parts or machine components or metal parts of a travelling device. The gantry device (10) comprises two lateral bipods (11), every bipod (11) having beam-type, elongate limbs (12) and a connecting element (13) and the limbs (12) being secured to said connecting element (13) with their top ends. The limbs have four extension elements (14), an extension element (14) being arranged on a lower end of every limb (12) or support (12) or beam (12). A cross member (15) extends between the two lateral bipods (11) and is secured to every end of the cross member (15) in the corresponding connecting element (13). The device (10) further comprises a trolley with a roller, which trolley is arranged on the cross member (15) in such a manner that it can be displaced along the cross member (15) in the area between the lateral bipods (11) or horizontally moved.

The invention relates to a gantry device for use in the mounting or maintenance of heavy parts of transport equipment.

Transport equipment in the sense of the invention, which can also be termed conveying equipment, is escalators and moving walkways with a plurality of tread elements or moving walkway plates, which are connected to form an endless conveyor. Users of the transport equipment stand on tread surfaces of the tread units or walk on the moving walkway plates in the same direction of movement as the transport equipment itself travels.

Very heavy and large components such as, for example, the drive unit must in part be installed or removed in the assembly and maintenance or repair of such transport equipment. Particularly heavy are, for example, the motor and the transmission, main shaft, axles and deflecting shafts as well as entire rail blocks.

Hitherto, large and very heavy lifting devices were for this purpose transported to the location of the transport equipment. For that purpose use is made of large trucks with a lifting crane. The lifting devices then have to be constructed on site before they can be used. These preparatory operations require a large logistical outlay and costs arise not just in the delivery of such lifting devices.

A further significant disadvantage of the previously employed lifting devices is that due to size and costs these exist only in limited numbers and accordingly deployments of these lifting devices have to be co-ordinated so that the lifting devices are in each instance ready for use at the right time at the right place. Due to their constructional form and size these are only conditionally usable in tight area or space conditions. In the case of use of the previously large and very heavy lifting device, erection in an atrium or erection near walls is possible only with difficulty or almost impossible.

Here the invention is to assist and facilitate or simply. The invention, as characterised in claim 1, fulfils the object in that it provides a novel lifting device which is very much more cost-advantageous in acquisition, but at the same time also simpler in use. The lifting device according to the invention, which here is termed gantry device for use in the mounting or maintenance of heavy parts of transport equipment, comprises at least the following elements: Two lateral bipods are provided, wherein each bipod has two strut-like elongate limbs and a connecting element. Each two limbs are fastened by the upper ends thereof to one of these connecting elements. In addition, four extension elements are provided, wherein one such extension element is arranged at a lower end of each limb. A cross member extends between the two lateral bipods and at each end of the cross member this is fastened in the corresponding connecting element. A gantry-shaped lifting device results from this form of arrangement. A crab with rollers is so arranged at the cross member that it is displaceable along the cross member in the region between the two lateral bipods. Thus, a horizontal displacement or paying out of the heavy mechanical parts is made possible.

The advantages achieved by the invention can be inferred from the description.

Preferred developments of the device according to the invention are defined by the dependent claims.

The invention is described in detail in the following by way of examples and with reference to the drawing, in which:

FIG. 1 shows a side view of an escalator;

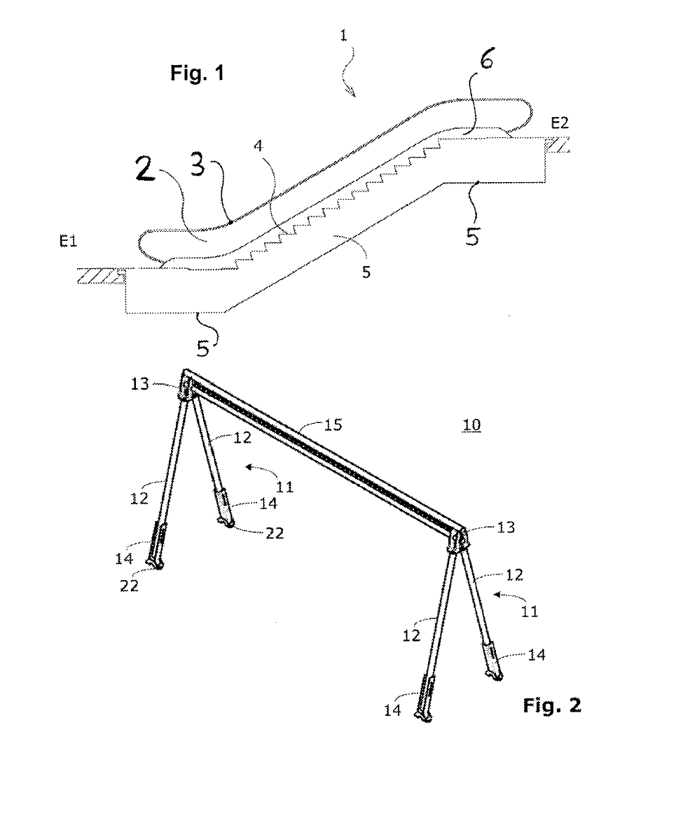

FIG. 2 shows a perspective view of a gantry device according to the invention;

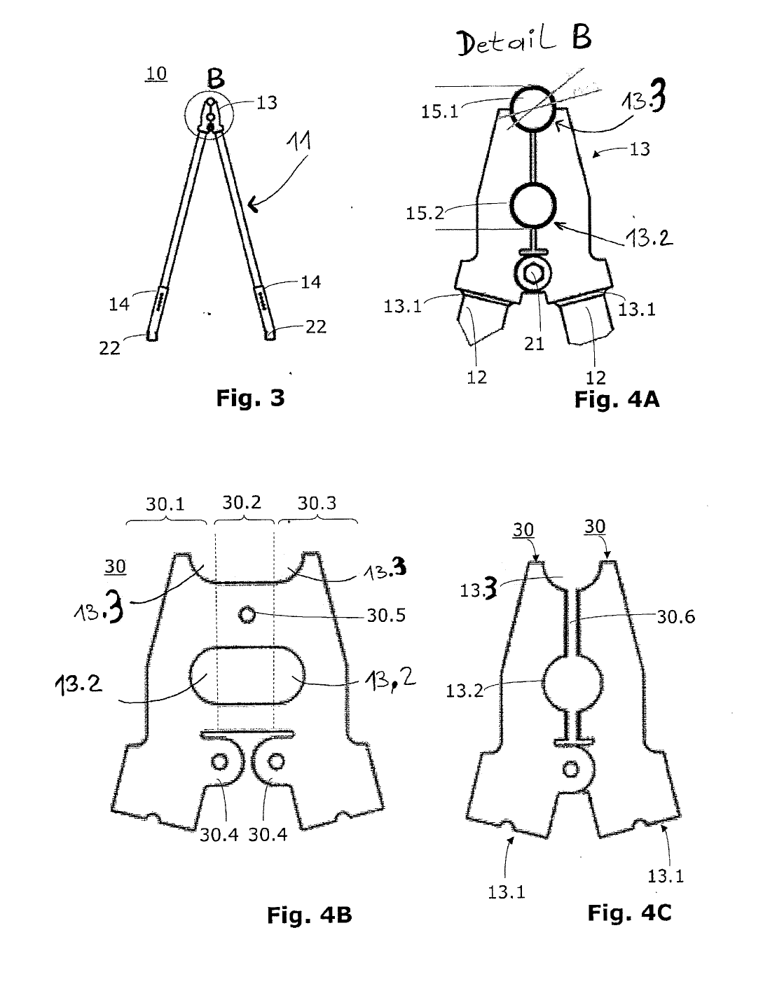

FIG. 3 shows a front view of the gantry device according to the invention in accordance with FIG. 2;

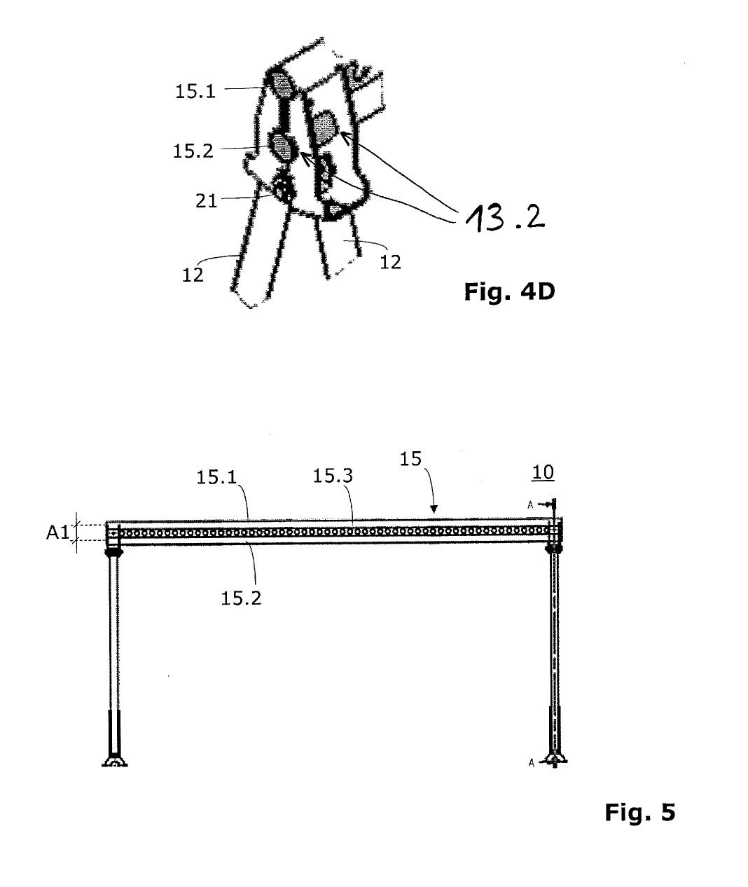

FIG. 4A shows an enlarged side view of a connecting element;

FIG. 4B shows a view of a punched or cut sheet metal part which is used as a component for production of a connecting element;

FIG. 4C shows a view of two punched or cut and three-dimensionally shaped sheet metal parts, which together provide a connecting element;

FIG. 4D shows a perspective view of the connecting element in accordance with FIG. 4A;

FIG. 5 shows a side view of the gantry device according to the invention in accordance with FIG. 2;

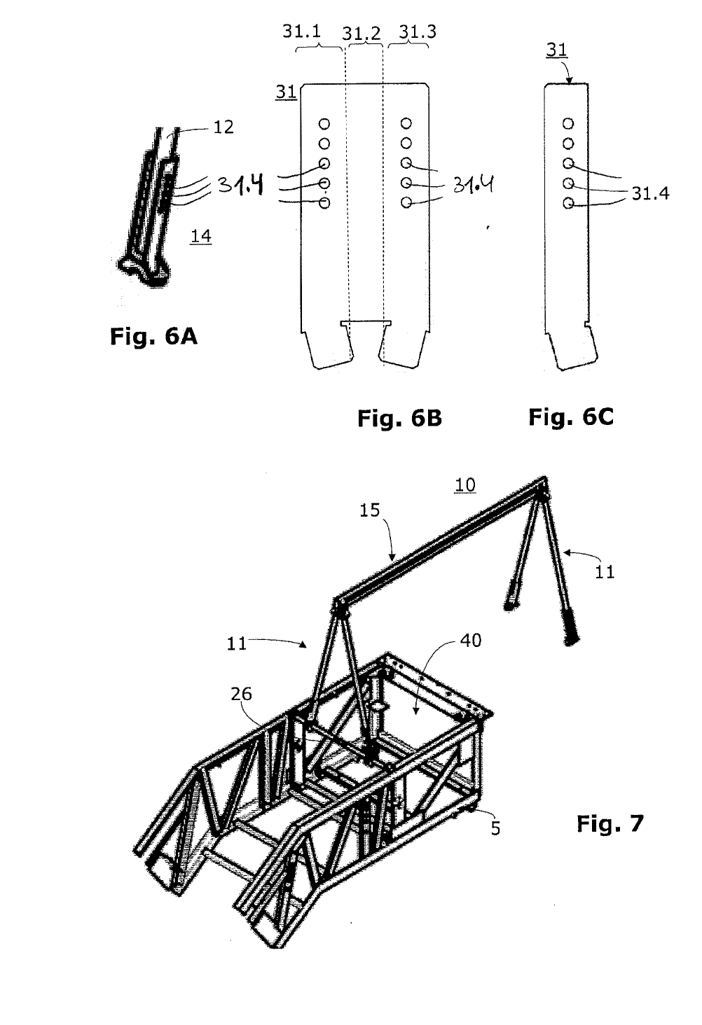

FIG. 6A shows an enlarged perspective view of an extension element;

FIG. 6B shows a view of a punched or cut sheet metal part which is used as a component for the production of an extension element;

FIG. 6C shows a view of the punched or cut and three-dimensionally shaped sheet metal part in accordance with FIG. 6B;

FIG. 7 shows a perspective view of a further gantry device according to the invention, which is supported on a framework or support structure of transport equipment;

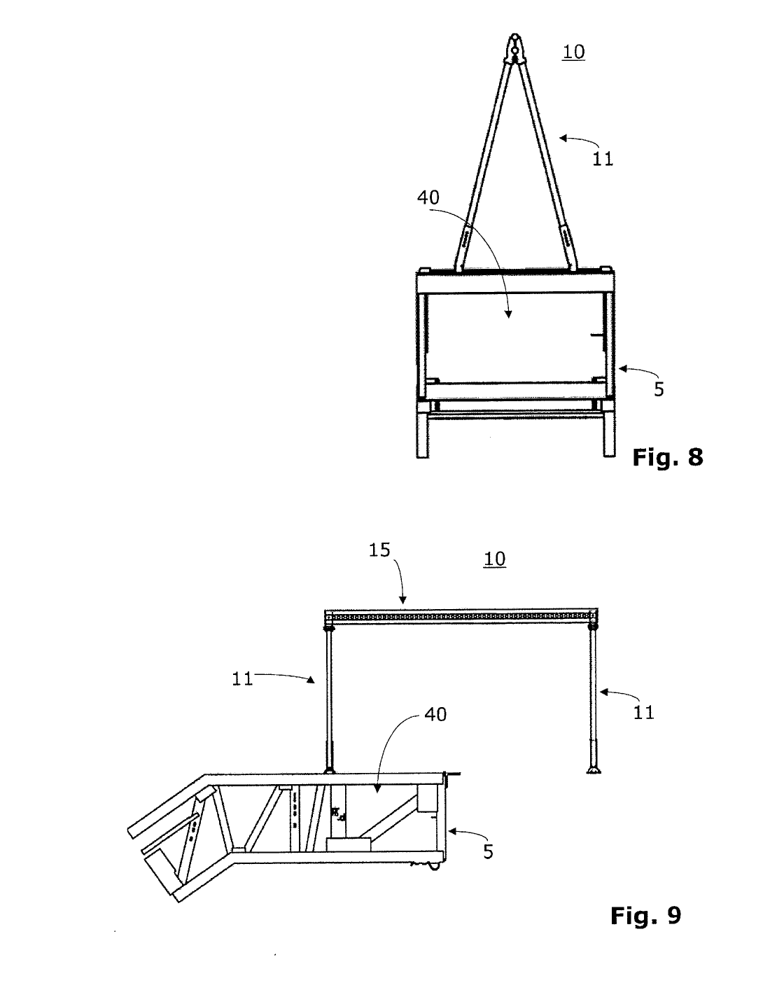

FIG. 8 shows a front view of the gantry device according to the invention with framework in accordance with FIG. 7;

FIG. 9 shows a side view of the framework with the gantry device according to the invention in accordance with FIG. 7;

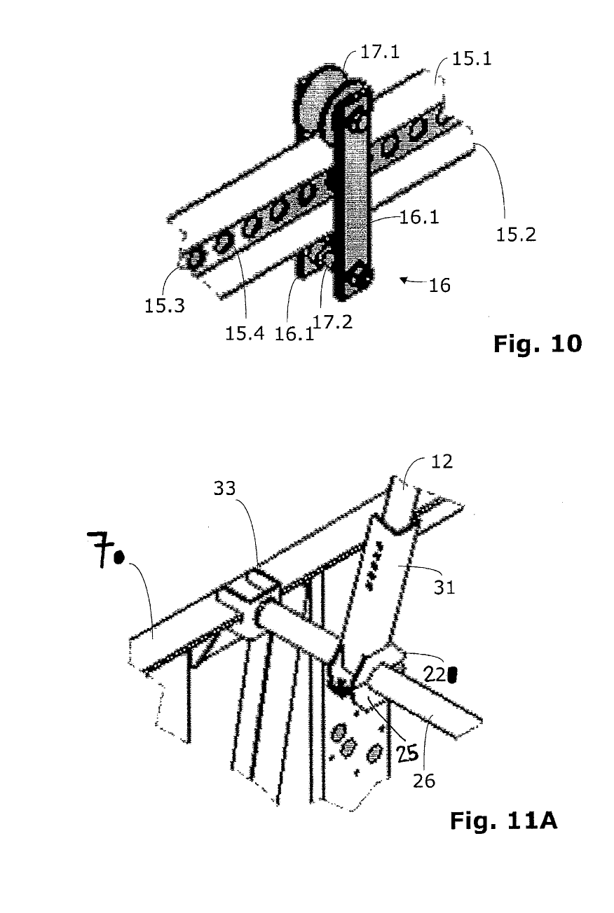

FIG. 10 shows an enlarged detail view of the cross member of a gantry device according to the invention with crab;

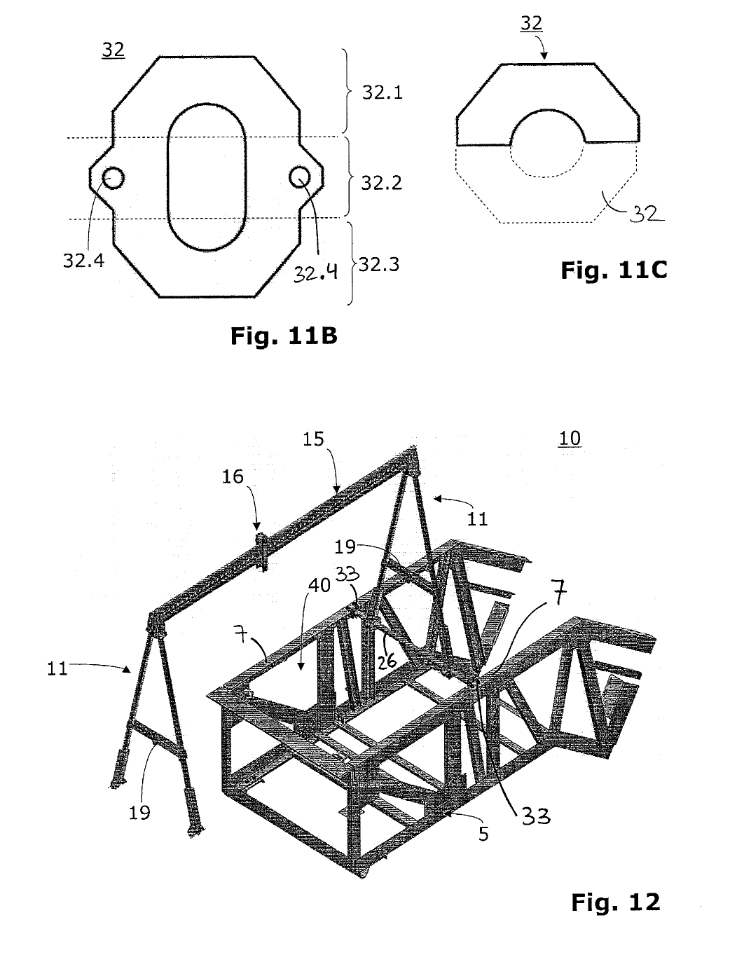

FIG. 11A shows an enlarged detail view, from which further details of the form of embodiment in accordance with FIG. 7 can be recognised;

FIG. 11B shows a view of a punched or cut sheet metal part which is used as a component for the production of a fastening element;

FIG. 11C shows a view of the punched or cut and three-dimensionally shaped sheet metal part in accordance with FIG. 11B; and

FIG. 12 shows a further perspective view of the gantry device according to the invention in accordance with FIG. 7.

FIG. 1 shows an escalator 1 or moving walkway 1 which connects a first floor E1 with a second floor E2. The escalator 1 comprises a step belt consisting of steps 4. In the case of a moving walkway 1 this comprises a plate belt consisting of plates. A handrail 3 is arranged at a balustrade 2, which is mounted at the lower end by means of a balustrade pedestal 6. Located below the balustrade pedestal 6 is a so-called framework 5, which is illustrated in FIG. 1 in strongly simplified form. This framework 5 (also termed support structure) serves as supporting steel frame for the escalator 1. Details of such a framework 5 or support structure 5 are to be seen in FIGS. 7, 8, 9 and 12.

In the further course of description the term ‘transport equipment’ is used instead of the term ‘escalator’ or ‘moving walkway’.

A first form of embodiment of the invention is shown in a perspective view in FIG. 2. This is a gantry device 10 which is designed specifically for use in the mounting or maintenance or repair of exchange of heavy mechanical components or metal parts of transport equipment 1. The gantry device 10 comprises two lateral bipods 11, wherein each of the bipods 11 comprises two strut-like, upright-like elongate limbs 12 and a connecting element 13. The limbs 12 are fastened by the upper ends thereof to this connecting element 13. This can be a screw, rivet, crimp, clinch or weld connection.

Four extension elements 14 are provided, wherein one such extension element 14 is arranged at a lower end of each limb 12. The extension elements 14 serve on the one hand as feet or rests or supports for the device 10 so as to ensure stable, firm standing. On the other hand, the extension elements 14 allow individual extension of each limb 12 for floor and height levelling (horizontal), since floor unevennesses are customary at a construction site.

The gantry device 10 additionally comprises a cross member 15 which extends ‘gantry-like’ between the two lateral bipods 11 and which is fastened at each end in the corresponding connecting element 13 or connecting scissors 13 or connecting clamp 13, as is illustrated in FIG. 2.

In order to be able to use the gantry device 10 as an efficient lifting tool, a crab 16 with two rollers 17 is present (see FIG. 10 and FIG. 12), which is so arranged at the cross member 15 that it is displaceable or movable along the cross member 15 in the region between the lateral bipods 11.

Further details of the gantry device 10 are described in the following. According to the invention it is important that the device 10 on the one hand is very stable and firm in order to be able to also lift large loads of 200 kilograms to 900 kilograms and on the other hand the device 10 should be light, capable of transport and economic as well as friendly to assembly. Only if it is light and if it can be constructed and dismantled easily does this device 10 fulfil its purpose as a ‘tool’ or aid which can be rapidly constructed and dismantled on site. Moreover, the gantry device 10 should be flexibly usable in order to be able to be differently constructed/configured and used according to the respective situation.

A front view of the gantry device is shown in FIG. 3. The bipod 11 can be seen in this view. The connecting element 13 is disposed in the upper region. The limbs 12 or uprights 12 or struts 12 are fastened or coupled to this connecting element 13. The limbs preferably stand at an angle between approximately 20 and approximately 40 degrees. The angle is fixed by the connecting element 13. According to the invention the two lateral bipods form, together with the connecting element 13 or connecting scissors 13 or connecting shackle 13, the shape of an inverted “V” or “V's”.

An extension element 14 is, as described, located at the lower end of each limb. Each extension element 14 has a foot 22 or foot region 22 on the underside. The extension element 14 or floor compensating element 14 serves the purpose of keeping the gantry device 10 horizontal and compensating for unevennesses.

The detail B of FIG. 3 is illustrated in FIG. 4A to enlarged scale. Details of the connecting element 13 can be seen in FIG. 4A. The limbs 12 or uprights 12 are, in the illustrated example, fastened or welded at the bottom in fastening regions 13.1. The ends of two horizontal cylindrical tubes or pipes 15.1, 15.2 or round irons or round steels 15.1, 15.2 of the cross member 15 can be seen in FIG. 4A. The end of the lower cylindrical tube 15.2 or pipe or round iron or round steel passes through a passage opening 13.2 of the connecting element 13. The end of the upper cylindrical tube 15.1 or pipe or round iron or round steel, the reagainst, rests in a support region 13.3 of the connecting element 13.

The connecting elements 13 or the connecting scissors 13 or connecting shackles 13 are made of punched or water-jet-cut or laser-cut or plasma-cut and subsequently three-dimensionally shaped sheet metal, preferably of stainless steel or zinc sheet or steel sheet. Such a sheet metal element 30 after the cutting or punching is shown in Fig. B. The two vertical dotted lines mark the lines along which the sheet metal element 30 is bent or reshaped in a further processing step. The section 30.1 remains in the drawing plane, whilst the middle region 30.2 together with the section 30.3 is bent rearwardly through 90 degrees. The section 30.3 is then bent again through 90 degrees in a further step. As seen from above, a component results which has the shape of a “U”. The U-shape is shown in the manner of an attachment in FIG. 4D. The tongues 30.4 with a hole for a screw 21 or threaded rod 21 are not bent.

Two pieces of such sheet metal elements 30 are now placed against one another as can be seen in FIG. 4C, i.e. the connecting element 13 is put together or assembled or mounted together as shown in FIG. 4C to form a single complete component.

The connecting elements 13 have two underneath fastening points 13.1 in order to be able to fasten the two upper ends of the limbs 12 or uprights 12 or struts 12. Beyond that, they have two passage holes 13.2 in order to be able to horizontally receive or plug in the circular end 15.2 of the cross member 15. In FIG. 4D it can be seen that there are two such passage holes 13.2 and, in particular, a first in the front vertical surface of the connecting element 13 and a second in the rear vertical surface of the connecting element 13. The hole 13.5 is used in order to be able to fasten the two sheet metal elements 30 and the cross member 15 together. The position of the corresponding screw connection 30.6 or peg connections 30.6 or dowel pin connections 30.6 is schematically indicated in FIG. 4C. In addition, the two sheet metal elements 30 are connected together by way of the tongues 30.4 or the holes thereof. The screw 21 or threaded rod 21 connects the sheet metal elements 30 of the connecting element 13 by way of the tongues 30.4.

The connecting elements 13 have two support regions 13.3 in order to be able to horizontally support the upper circular end 15.1 of the cross member 15 and the receiving region 13.2 in order to be able to horizontally receive the lower circular end 15.2 of the cross member 15.

Due to the fact that each connecting element 13 is composed of two identical sheet metal components 30 not only the costs for these connecting elements 13, but also the weight thereof are low. The same also applies to other elements of the device 20 as is described in the following.

FIG. 5 shows further details of the gantry device 10 in a side view. It can be seen in this view that the cross member 15 comprises at least two parallelly extending cylindrical tubes 15.1, 15.2 or pipes 15.1, 15.2 or round irons or round steels 15.1, 15.2, which are arranged and fastened at a uniform spacing A1 from one another. A metal plate which serves as a (connecting) web 15.3 is disposed in the intermediate space between the pipes or round steels 15.1 and 15.2. Several holes 15.4 are preferably formed in the web 15.3 in order to be able to fasten thereto mounting chains, hooks, shackles, spring hooks, elongate hook crossbars, grippers, pulley blocks, wire cables, polypropylene cables, lashing straps, eye clips, clamps, load cells, tension force measuring instruments, equaliser spring trains, high-strength eyebolts, latches, diverse slings and the like. In addition, a weight reduction is given by the holes 15.4. Details can be seen in FIG. 10.

Further aspects of the invention are illustrated in FIGS. 6A to 6C. An extension element 14, which is fastened to a lower end of the limb 12 or upright 12 or strut 12, is shown in FIG. 6A. The extension element 14 or levelling element 14 is made of a punched or cut and three-dimensionally shaped sheet metal element 31. The corresponding element 31 is shown in FIG. 6B after the punching, but before the shaping. The two vertical dotted lines mark the lines along which the sheet metal element 31 is bent or reshaped in a further processing step. The section 31.1 remains in the drawing plane, whilst the middle region 31.2 together with the section 31.3 is bent rearwardly through 90 degrees. The section 31.3 is then bent again through 90 degrees in a further step. As seen from above, a component 31 results which has the shape of a “U”. This U-profile has an inner diameter or a clear inner width which is somewhat larger than the outer diameter of the limbs 12 or uprights 12 or struts 12. As can be seen in FIG. 6A, the component 31, after it has been punched or cut and reshaped, is individually fastened to the lower end of the limb 12 or upright 12 or strut 12. The holes 31.4 are used in order to fix the extension element 14 or levelling element 14 to the limb 12 or upright 12 or strut 12. For this purpose the limb 12 or upright 12 or strut 12 also has corresponding counter-holes or receiving holes in the lower region. Several such holes 31.4 are present in order to be able to displace the extension element 14 downwardly or upwardly. Each limb 12 or upright 12 or strut 12 can thereby be individually extended or shortened, whereby a perfect and precise compensation for level is produced.

The gantry device 10, which was described in the foregoing, can be placed near the transport equipment 1 or over the transport equipment 1 (like a bridge). Heavy mechanical components or metal elements can be lifted out of an escalator pit 40 or moving walkway pit 40 or lowered or dropped into the pit 40 by means of a chain hoist or crab 16, which serves as hoisting gear.

Details of a particularly preferred form of embodiment are shown in FIGS. 7, 8 and 9. This concerns a gantry device 10 which can be fastened by two limbs 12 or uprights 12 or struts 12 on a horizontal (cross) tube 26 or (cross) beam 26 or crossbar 26, which can be inserted in the framework frame 5 or the framework 5 or support structure 5 of the transport equipment 1. Through this form of arrangement it is possible to firmly connect the device 10 with the framework 5 or support structure 5 or framework frame 5 with little effort. The cross member 15 is now disposed in part above the escalator pit 40 or moving walkway pit 40 of the framework 5. Heavy drive elements, for example the motor or the complete drive unit or the main shaft of the transport equipment 1, can thus be lifted out of the pit 40 easily and simply and smoothly and quickly and without problems.

The correspondingly mounted gantry device 10 is shown in front view in FIG. 8 and in side view in FIG. 9.

Details of a possible crab 16 which is moved along the cross member 15 are shown in FIG. 10. The crab 16 preferably has an upper roller 17.1 and a smaller lower roller 17.2 and/or a lower carrying axle 17.2. A block-and-tackle or a lifting hoist can be inserted or hung in the carrying axle 17.2 of the crab 16, whereby the heavy loads or the heavy mechanical components can be raised and/or manipulated or moved horizontally. Two sheet steel elements 16.1 or sheet metal strips 16.1 or U-sections 16.1 or angle sections 16.1 are disposed laterally. The crab 16 can have a small drive (not shown) in order to be able to lift heavy mechanical parts or metal elements by means of a chain. However, use can also be made of a form of block-and-tackle with chains or steel cables, which is driven manually or by motor.

FIG. 11A shows details of the temporary fastening of the gantry device 10 on a (cross) tube 26 or crossbar 26. Mounted on the foot 22 of the limb 12 or upright 12 or strut 12 is a fastening means 25 which clamps around the tube 26 or crossbar 26. The fastening means 25 enclose the foot region 22 of the limb 12 or upright 12 or strut 12 and thus connect the limb 12 in stable manner with the tube 26. The tube 26 or the crossbar 26 itself has at each of the two ends a respective fastening means or fork 33. These fastening means or forks 33 allow simple installation or insertion of the tube 26 or crossbar 26 between two longitudinal beams 7 of the framework 5 or supporting structure 5.

The fastening means 25 comprise per limb 12 two identical punched or cut and three-dimensionally shaped sheet metal components 32, preferably of steel sheet or stainless steel or zinc sheet. Such a sheet metal component 32 after cutting or punching is shown in FIG. 11B. The two horizontal lines mark the lines along which the sheet metal component 32 is bent or reshaped in a further processing step. The section 32.1 remains in the drawing plane, whilst the middle region 32.2 together with the section 32.3 is bent rearwardly through 90 degrees. The section 32.3 is then bent again through 90 degrees in a further step. As seen from the side, a sheet metal component 32 having the form of “U's” results. The U-shape can be seen in the manner of an attachment in FIG. 11A. The holes 32.4 are used in order to be able to join two such sheet metal components 32 together to form a clamp 25 or clip 25 or fastening means 25. The additional second sheet metal component 32 (2 pieces) is indicated by a dashed continuous line in FIG. 11C.

Another perspective illustration of the preferred form of embodiment of the invention is shown in FIG. 12. The gantry device 10 is supported, as seen on the right in the drawing, on a demountable (cross) tube 26 or crossbar 26 in the framework 5 or support structure 5. As seen on the left in the drawing the gantry device 10 stands by both limbs 12 or uprights 12 or struts 12 of the bipod 11 on the floor or on the rough coating of the mounting location. A crab 16 is movable or adjustable along the cross member 15 and can be adjusted or positioned as desired above the pit 40. In order to impart further stability to the device 10 two cross braces 19 are provided which prevent the limbs 12 or uprights 12 or posts 12 of the two bipods 11 being forced apart or compressed in the case of greater loading or excessive stressing.

The device 10 is light and favourable in cost. Handling is very simple and few steps are needed in order to construct or dismantle the device 10. Moreover, the device 10 is usable very flexibly and universally. In addition, the gantry device 10 can be used several times per day at different locations and is no longer confined to a location for a lengthy time. Beyond that, the standstill time of the escalator or moving walkway is substantially shortened and the operator gains considerable added value or substantial additional utilisation.

As described, the invention can be used equally on escalators and moving walkways.

1-15. (canceled)

16. A gantry device for use in the mounting or maintenance of heavy parts of transport equipment, wherein the gantry device comprises:
two lateral bipods, wherein each of the bipods comprises two strut-like elongate limbs and a connecting element, the limbs being fastened at upper ends thereof to the connecting element;
an extension element located at a lower end of each limb; and
a cross member extending between the two lateral bipods and fastened to the two lateral bipods through the corresponding connecting element.

17. A gantry device according to claim 16, further comprising a crab with at least one roller, the crab being movable along the cross member in a region between the lateral bipods.

18. A gantry device according to claim 16 or 17, wherein each of the two lateral bipods together with the corresponding connecting element have the form of an inverted “V”.

19. A gantry device according to claim 16 or 17, wherein the connecting elements are formed of three-dimensionally shaped sheet metal, each connecting element having:
two underneath fastening points adapted to fasten upper ends of the corresponding limbs,
two passage holes for horizontal insertion of a first circular end of the cross member, and
two support regions for horizontal support of a second circular end of the cross member.

20. A gantry device according to claim 19, wherein each connecting element is comprised of two identical sheet metal sections and in an assembled state has a U-shape as seen from a side, wherein the underneath fastening points lie in a lower transverse region of the U-shape and at least one of the passage holes and the support regions lie in lateral limbs of the U shape.

21. A gantry device according to claim 20, wherein the two sheet metal sections are held together by at least one of a screw connection, threaded rod connection or bolt connection.

22. A gantry device according to claim 16 or 17, wherein the cross member comprises at least two parallel members arranged at a uniform spacing from one another and wherein a metal plate serving as a web is disposed in an intermediate space between the members.

23. A gantry device according to claim 16 or 17, wherein each extension element has length adjusting means for the limb and has at least one foot.

24. A gantry device according to claim 16 or 17, wherein each extension element is made of two identical three-dimensionally shaped sheet components.

25. A gantry device according to claim 16 or 17, wherein at least one of the lateral bipods includes a horizontal crossbar and fastening means connecting the crossbar to the bipod.

26. The combination of a gantry device according to claim 25 and a transport equipment, wherein the crossbar is constructed and dimensioned for insertion between two longitudinal girders of a framework of the transport equipment, and wherein the gantry device in a mounted state is at least partly supported on the framework.

27. A gantry device (10) according to claim 25, wherein the fastening means for each limb is made of two identical three-dimensionally shaped sheet metal components.

28. A gantry device according to claim 16 or 17, wherein the cross member has a length of at least 1000 millimeters.

29. A gantry device according to claim 16 or 17, wherein the cross member has a length of 3000 millimeters and a weight of 21 kilograms.

30. A gantry device according to claim 16 or 17, wherein the cross member has a length of 3000 millimeters and a weight of 39 kilograms.
